(19) United States
(12) Patent Application Publication
(10) Pub. No.: US 2022/0240090 A1
(43) Pub. Date: Jul. 28, 2022

(54) Secure Mobile Devices

(71) Applicant: Miguel Antonio Vargas, Cartago (CR)

(72) Inventor: Miguel Antonio Vargas, Cartago (CR)

(21) Appl. No.: 17/585,036

(22) Filed: Jan. 26, 2022

Related U.S. Application Data
(60) Provisional application No. 63/142,182, filed on Jan. 27, 2021.

(51) Int. Cl. H04W 12/082

(52) U.S. Cl. CPC H04W 12/082

(57) ABSTRACT

A mobile device includes a body configured to be worn by a user; a lock switchable between an open state and a closed state, where, when the lock is in the closed state, the mobile device is prevented from being removed from the user; and a wireless data system, where the wireless data system and the lock are jointly configured such that, when the lock is open, the wireless data system is at least partially disabled.

### CLAIM OF PRIORITY

This application claims priority to U.S. Provisional Patent Application Ser. No. 63/142,182, filed on Jan. 27, 2021, the entire contents of which are hereby incorporated by reference.

### FIELD OF THE DISCLOSURE

The present disclosure relates to mobile devices including security-enhancing components.

### BACKGROUND

Auto identification and data capture (AIDC) systems are usable to transfer information or track people and objects in various environments. Some AIDC systems include wireless components that transmit signals to and/or receive signals from other devices.

### SUMMARY

In one aspect, the present disclosure describes a mobile device including a body configured to be worn by a user; a lock switchable between an open state and a closed state, where, when the lock is in the closed state, the mobile device is prevented from being removed from the user; and a wireless data system. The wireless data system and the lock are jointly configured such that, when the lock is open, the wireless data system is at least partially disabled.

Implementations of the mobile device may include any one or more of at least the following features. The wireless data system includes a data chip and an antenna. When the lock is in the open state, the data chip and the antenna are electrically disconnected, and, when the lock is in the closed state, the data chip and the antenna are electrically connected. The lock includes a movable conductor. When the lock is in the open state, the movable conductor is in a first position that causes the wireless data system to be at least partially disabled, and, when the lock is in the closed state, the movable conductor is in a second position that causes the wireless data system to be enabled. The wireless data system includes an antenna, and, when the lock is in the open state, a Faraday shield of the mobile device is in a first position such that the Faraday shield blocks the antenna and causes the wireless data system to be at least partially disabled, and, when the lock is in the closed state, the Faraday shield is in a second position such that the wireless data system is enabled. Movement of the lock between the open state and the closed state causes movement of the Faraday shield between the first position and the second position. The mobile device includes a power reception system. The power reception system and the lock are jointly configured such that, when the lock is in the closed state, the power reception system is disabled.

The present disclosure also describes a mobile device including a wireless data system and a physical, user-accessible control that switches the wireless data system between an enabled state and a disabled state. At least some functions of the wireless data system are disabled in the disabled state compared to the enabled state.

Implementations of the mobile device may include any one or more of at least the following features. The control includes a Faraday shield that blocks an antenna of the wireless data system when the control is in a position corresponding to the disabled state of the wireless data system. The wireless data system includes a data chip and an antenna, and the control includes a movable conductor that electrically connects the data chip to the antenna when the control is in a position corresponding to the enabled state of the wireless data system. The mobile device includes a lock switchable between an open state and a closed state. When the lock is in the closed state, the mobile device is prevented from being removed from the user, and the control and the lock are jointly configured such that, when the lock is in the open state, the control is in a state corresponding to the disabled state of the wireless data system. The mobile device includes a plurality of additional wireless data systems, each additional wireless data system providing a different corresponding functionality, and one or more additional physical, user-accessible controls that switch the plurality of additional wireless data systems between respective enabled states and disabled states.

The present disclosure also describes a mobile device including one or more wireless data systems and an anti-breach system configured to at least partially disable a first wireless data system in response to an unauthorized event.

Implementations of the mobile device may include any one or more of at least the following features. The first wireless data system or another wireless data system is configured to receive a wireless proximity signal, and the unauthorized event includes a failure to receive the wireless proximity signal by the first wireless data system or by another wireless data system. The first wireless data system or another wireless data system is configured to receive a wireless alert signal, and the unauthorized event includes receiving the wireless alert signal by the first wireless data system or another wireless data system. The anti-breach system includes a conductive strip, and the unauthorized event includes a severing of the conductive strip. The anti-breach system includes a sensor configured to detect one or more of a strain, a force, or a physical violation applied to the mobile device, and the unauthorized event includes a strain greater than a predetermined magnitude of strain, a force greater than a predetermined magnitude of force, or a predetermined physical violation. The mobile device includes a biometric input system. The unauthorized event includes receiving, by the biometric input system, biometric data that does not match biometric data stored on the mobile device.

Implementations of the mobile device may instead, or additionally, include any one or more of at least the following features. At least partially disabling the first wireless data system includes causing an electrical charge to damage a portion of the mobile device. At least partially disabling the first wireless data system includes releasing a chemical that damages a portion of the mobile device. At least partially disabling the first wireless data system includes releasing a spring-loaded component that damages a portion of the mobile device. At least partially disabling the first wireless data system includes causing a Faraday shield to block an antenna of the mobile device. In response to the unauthorized event, the anti-breach system is configured to cause a second wireless data system to emit a wireless signal indicative of the unauthorized event. The mobile device includes an alert component. In response to the unauthorized event, the anti-breach system is configured to cause the alert component to generate an alert indicator.

The present disclosure also describes a secure system including a mobile device, the mobile device including a body configured to be worn by a user, and a lock switchable between an open state and a closed state. When the lock is in the closed position, the mobile device is prevented from being removed from the user, and the lock is configured to switch between the open position and the closed position in response to the mobile device receiving a wireless signal. The secure system also includes a base station configured to transmit the wireless signal.

Implementations of the secure system may include any one or more of at least the following features. The mobile device includes a wireless data system configured to perform operations including extracting a device ID from the wireless signal; determining that the device ID is associated with the mobile device; and based on determining that the device ID is associated with the mobile device, causing the lock to switch states. The mobile device includes an anti-breach system configured to perform one or more operations in response to an unauthorized event. The mobile device includes a wireless data system configured to receive a wireless proximity signal, and the unauthorized event includes a failure to receive the wireless proximity signal. The base station is configured to emit the wireless proximity signal. The mobile device includes a wireless data system configured to receive a wireless alert signal, and the unauthorized event includes receiving the wireless alert signal. The base station is configured to emit the wireless alert signal. The anti-breach system includes a conductive strip, and the unauthorized event includes a severing of the conductive strip. The anti-breach system includes a sensor configured to detect one or more of a strain, a force, or a physical violation applied to the mobile device, and the unauthorized event includes a strain greater than a predetermined magnitude of strain, a force greater than a predetermined magnitude of force, or a predetermined physical violation. The mobile device includes a biometric input system, and the unauthorized event includes receiving, by the biometric input system, biometric data that does not match biometric data stored on the mobile device.

Implementations of the secure system may instead, or additionally, include any one or more of at least the following features. The one or more operations include causing an electrical charge to damage a portion of the mobile device. The one or more operations include releasing a chemical that damages a portion of the mobile device. The one or more operations include releasing a spring-loaded component that damages a portion of the mobile device. The one or more operations include causing a Faraday shield to block an antenna of the mobile device. The mobile device includes a wireless data system, and the wireless data system and the lock are jointly configured such that, when the lock is in the open state, the wireless data system is at least partially disabled. The mobile device includes a wireless data system, and the mobile device includes a physical, user-accessible control that switches the wireless data system between an enabled state and a disabled state. At least some functions of the wireless data system are disabled in the disabled state compared to the enabled state. The control includes a Faraday shield that blocks an antenna of the wireless data system when the control is in a state corresponding to the disabled state of the wireless data system. The wireless data system includes a data chip and an antenna, and the control includes a movable conductor that electrically connects the data chip to the antenna when the control is in a state corresponding to the enabled state of the wireless data system. The control and the lock are jointly configured such that, when the lock is in the open state, the control is in a state corresponding to the disabled state of the wireless data system.

Implementations of the secure system may instead, or additionally, include any one or more of at least the following features. The mobile device includes a plurality of wireless data systems, each wireless data system providing a different corresponding functionality; and one or more physical, user-accessible controls that switch the plurality of wireless data systems between respective enabled states and disabled states. The mobile device includes a wireless data system and a biometric input system. The wireless data system is configured to be enabled based on comparing biometric data received by the biometric input system to biometric data stored in the mobile device. The base station includes a charging component configured to charge the mobile device, the mobile device includes a wireless data system, and the wireless data system is at least partially disabled while the mobile device is being charged by the base station. The mobile device includes a power reception system configured to couple to the charging component. The power reception system and the lock are jointly configured such that, when the lock is in the closed state, the power reception system is disabled. The base station includes a second mobile device.

Embodiments of the subject matter described in this specification can be implemented to realize one or more of at least the following advantages. For example, in some implementations, a wearable device is prevented from being removed without authorization. In some implementations, systems and functions of mobile devices can be disabled more securely. In some implementations, data and functions of a mobile device can be more securely safeguarded in case of a breach of the mobile device. In some implementations, a subset of operations of a mobile device may be activated without requiring sophisticated electronic selection components.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a schematic of an example mobile device.

FIGS. 2A-2D are views of example mobile devices.

FIGS. 3A-3I are perspective and section views of example locks.

FIG. 4 is a schematic of an example biometric input system.

FIG. 5A is a perspective view and associated schematics of an example mobile device and base station.

FIGS. 5B-5C are perspective views of example base stations.

FIG. 6 is a schematic of an example wireless data system.

FIG. 7A is a schematic of an example anti-breach system.

FIG. 7B is a perspective view of an example mobile device.

FIGS. 8A-8K are orthogonal views of example anti-breach systems.

FIG. 9A is a perspective view of an example user-configurable control.

FIG. 9B is an exploded view of an example user-configurable control.

FIG. 10A is a perspective view of an example user-configurable control.

FIGS. 10B-10C are schematics of an example user-configurable control.

FIG. 11 is a schematic perspective of an example user-configurable control.

FIG. 12A is a perspective view of an example mobile device.

FIG. 12B is an exploded view of an example user-configurable control.

FIG. 13 is a perspective view of an example mobile device.

### DETAILED DESCRIPTION

Lightweight, custom-purpose mobile devices serve important functions in network-integrated spaces. These devices often include one or more auto identification and data capture (AIDC) systems, which allow for the mobile devices to be tracked by image recognition or signal reception systems. Besides location tracking, the mobile devices often can perform one or more on-demand functions, for example, requesting access to a secure facility, performing data upload and/or download, or authorizing payment operations.

In one example, mobile wearable devices may be issued to each person entering a secure area, such as a laboratory. Each wearable device includes a tracking radio-frequency identification (RFID) system, Bluetooth system, indoor GPS system, or other location tracking system that allows the location of each person to be tracked by the location tracking system as they move throughout the laboratory. Moreover, each wearable device includes a suite of on-demand function systems appropriate to the person wearing the wearable device. For example, a scientist's wearable device includes a first RFID circuit usable to operate equipment in the laboratory, a second RFID circuit usable to open doors within the laboratory, and a third RFID circuit that irreparably damages the first and/or second RFID circuit if the wearable device detects that it has left the laboratory; a security guard's wearable device includes only the second and third RFID circuits; and a visitor's RFID device includes only the tracking RFID system.

In another example, a user of an expensive smartwatch can lock the smartwatch to their wrist before leaving home. The smartwatch cannot be removed without receiving a signal from a base station at home, deterring potential thieves and preventing accidental loss. If the smartwatch is removed without authorization from the base station (e.g., by being cut or drilled off), components of the smartwatch are automatically destroyed, disincentivizing theft.

This disclosure describes a suite of devices and systems that may be used, individually or in combination, to maintain the security of mobile devices. The systems can include locks, wireless data systems, biometric input systems, and anti-breach systems, and user controls, any or all of which may interact with one another to provide security and functionality. For example, the different functionalities of each wearable device in the laboratory example are determined by wireless data systems included in the wearable device, and these wireless data systems can be enabled and disabled based on a state of a lock of the wearable device and/or by a user control that physically blocks wireless signals or allows the wireless signals to pass. In the smartwatch example, an anti-breach system of the smartwatch can detect a break in circuit continuity and trigger a spring-coupled mechanism to destroy a portion of a wireless data system. These and other possible interactions are described in detail throughout this disclosure.

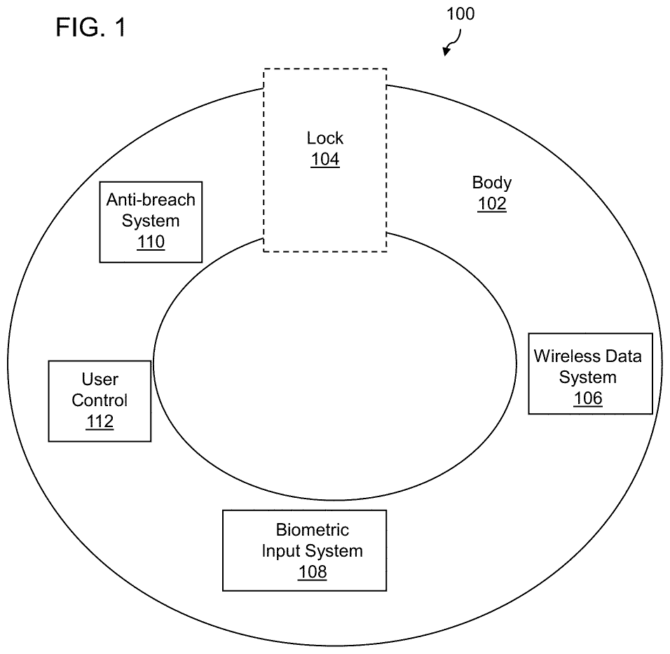

As shown in FIG. 1, a mobile device 100 includes several systems that work, together or individually, to provide enhanced security and protection. Briefly, these systems include a body 102, a lock 104, one or more wireless data systems 106, a biometric input system 108, an anti-breach system 110, and one or more user controls 112. Details on each of these systems, and their possible interactions in different implementations, are described throughout this disclosure.

Although these systems are shown in FIG. 1 as discrete, separate systems, in various implementations one or more of the systems may be combined into a single system that provides combined functionalities. Moreover, each of the systems need not be present in each mobile device: various implementations may include one, some, or all of the systems described herein.

The body 102 of the mobile device 100 houses some or all of the systems of the mobile device 100. The body 102 may include one or a mixture of plastic, metal, rubber, wood, or another material, and may be hollow, solid, or both in different locations of the body 102. In some implementations, the body 102 is partially or entirely flexible, such that the body 102 can be reshaped to change size (e.g., to fit into a pocket) or to fit around different body parts (e.g., a large loop may be worn around the neck of a user, or the loop may be folded upon itself to fit more compactly around a wrist of the user).

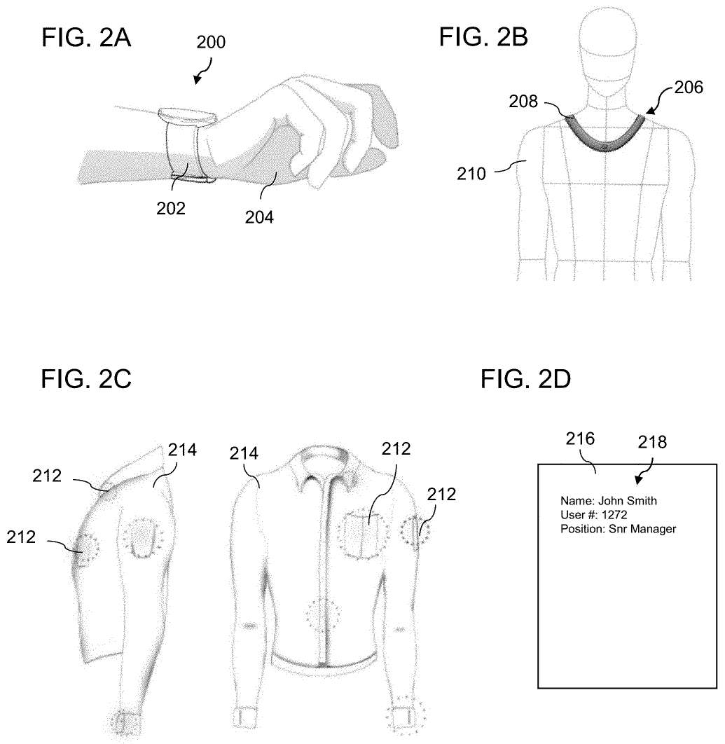

The body 102 may have various shapes, depending on the implementation. In some implementations, the mobile device 100 is a wearable device configured to be worn by a user. As shown in FIG. 2A, in some implementations a mobile device 200 includes a looped body 202 configured to be worn around the wrist of a user 204 as a bracelet. Because users' arms are easily manipulable, the bracelet configuration may make it easier for users to move the mobile device to particular locations, e.g., into close proximity with a base station or interactive device.

As shown in FIG. 2B, in some implementations a mobile device 206 includes a looped body 208 configured to be worn around the neck or upper torso of a user 210 as a necklace.

As shown in FIG. 2C, in some implementations one or more mobile devices (e.g., mobile devices 212) are integrated into a clothing item 214, e.g., a uniform. For example, the mobile devices may be embedded into fabric of the clothing item 214 (e.g., sewn between layers of the clothing item 214). In such an implementation, the body of the mobile device may be flat, elongated, or another shape that allows the mobile device 212 to be integrated into the clothing item 214.

In some implementations, the mobile device is integrated into an opening and closure system of another item. For example, the mobile device may be integrated into an opening and closure mechanism of a luggage item (e.g., a zippering system) to control access to the contents of the luggage item.

The mobile device need not be particularly configured to be worn by a user. As shown in FIG. 2D, in some implementations, a mobile device 216 is a smart card. The smart card may be attached to a necklace and worn around the neck of the user, kept in a pocket of the user, etc. The smart card may include printed identifying information 218 on its surface, thus serving a dual function as both smart device and non-electronic identification card.

The implementations shown in FIGS. 2A-2D are non-limiting examples. Various shapes and configurations of the mobile device are possible depending on the particular needs of users. In addition, in some implementations mobile devices are attached to objects, e.g., products or sensitive materials, as part of an electronic article surveillance system.

As shown in FIG. 1, in some implementations the mobile device 100 includes a lock 104. The lock 104 may function as an attachment lock on a wearable mobile device, e.g., the lock 104 may include a bracelet clasp that locks the mobile device in position on a user's wrist. However, the lock 104 need not be tied to a wearable functionality of the mobile device 100 and need not physically lock the mobile device 100 into a particular configuration. In some implementations, the lock 104 switches the device between an “open” state in which a first set of functions and/or systems of the mobile device are enabled and a “closed” state in which a second set of functions and/or systems are enabled. In some implementations, the open and closed states correspond to an attached/detached state of the mobile device, respectively. In some implementations, the open and closed states are independent from the physical configuration of the mobile device 100. The first set of functions and/or systems enabled by the “open” state may be the same as or different from the second set of functions enabled by the “closed” state.

As described in further detail throughout this disclosure, the functions and/or systems that may be enabled or disabled based on lock state may include wireless data systems and the functions thereof, based on, for example, reconfiguring of circuit elements of the wireless data systems, blocking of wireless signals sent to/from the wireless data systems, or other mechanical alterations to the wireless data systems.

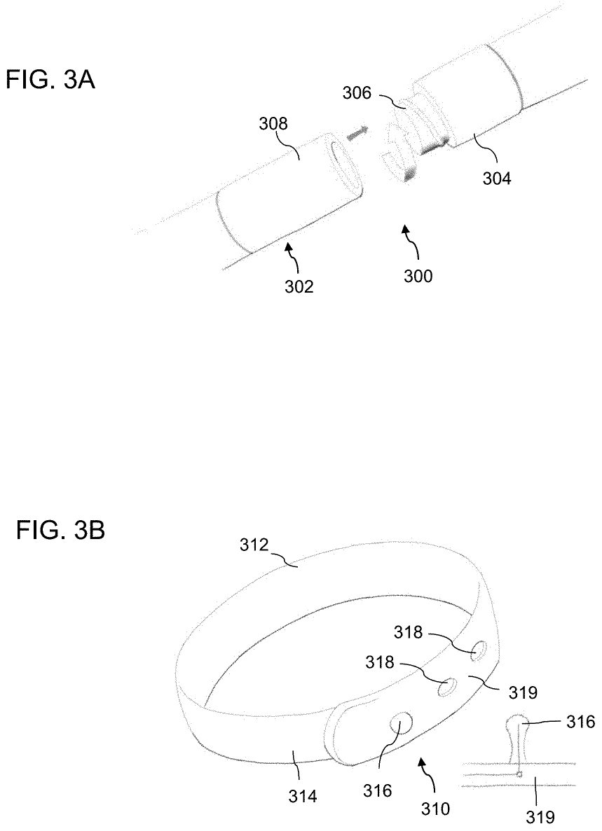

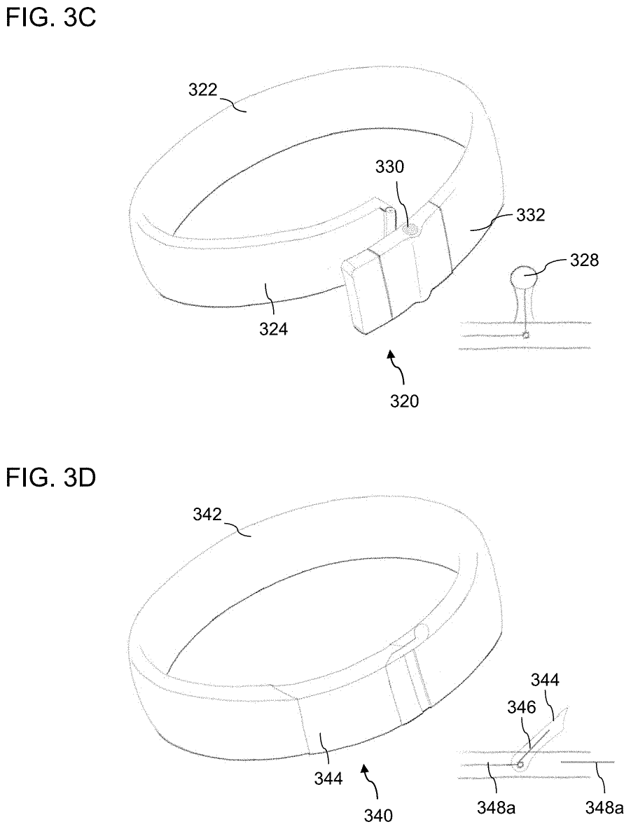

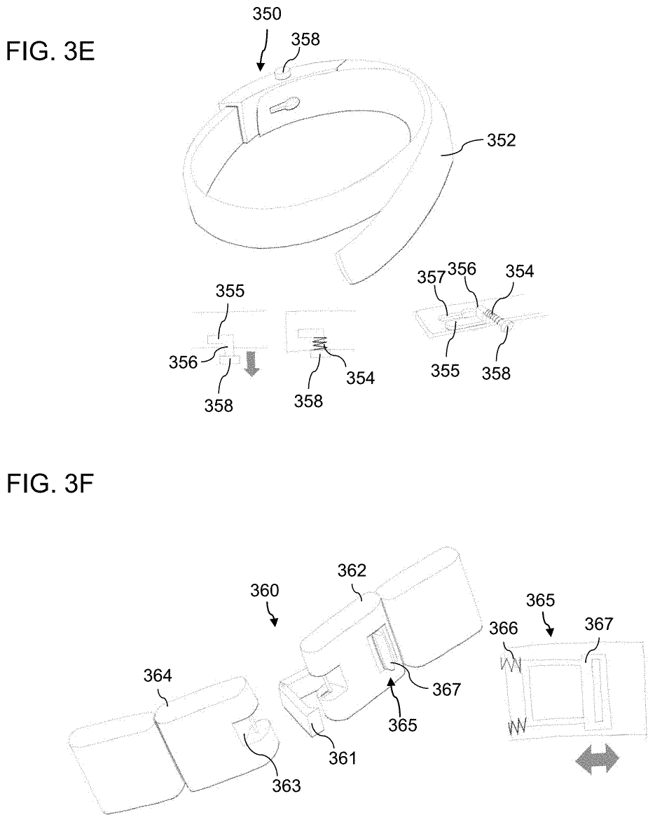

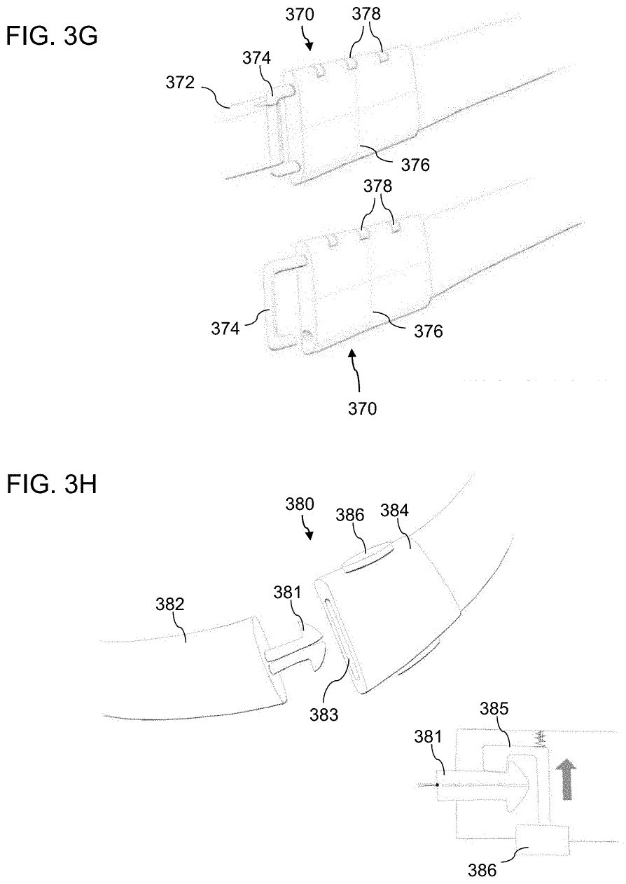

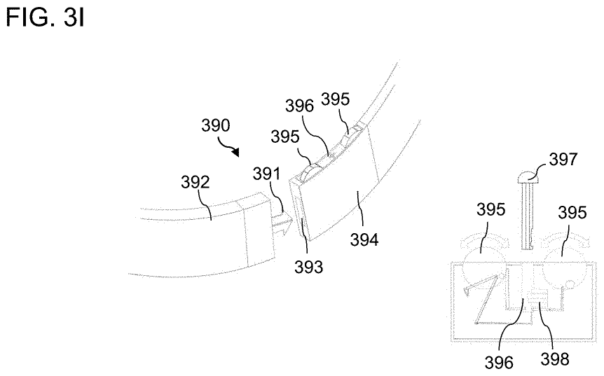

FIG. 3A shows an example screwed lock 300. A first side 302 of the screwed lock 300 includes internal threads, while a second side 304 includes a screw 306 configured to screw into the internal threads. A twistable portion 308 may be manipulated by a user to lock and unlock (close and open) the screwed lock 300.

In some implementations, when the screwed lock 300 is closed, a circuit connection of the mobile device is formed. For example, metal or otherwise conductive portions of the first side 302 and the second side 304 may come into contact when the screwed lock 300 is closed, thereby connecting two circuit elements of the mobile device (e.g., an antenna and a data chip, a battery and a data chip, other internal components of wireless data systems, etc.). The connection of the circuit elements may enable one or more functions and/or systems of the mobile device that are disabled in the absence of the connection, such as the circuit elements that are connected by closure of the lock. Alternatively or additionally, one or more functions/systems of the mobile device may become disabled when the connection is formed, being enabled only when the lock is in the open (circuit disconnected) state.

In some implementations, the lock state indicates to an electrical sensor (e.g., by a corresponding voltage or current created by a closed or opened electrical connection, by a corresponding sensed position of a component of the lock, or by a corresponding sensed strain or pressure caused by a position of a component of the lock) that the mobile device is in a closed state, and the sensor correspondingly outputs a signal indicative of the closed state to one or more other systems of the mobile device, the one or more other systems becoming correspondingly enabled or disabled based on their configuration.

FIG. 3B shows an example buckle-hole lock 310 in a mobile device 312. A first side 314 of the mobile device 312 includes a buckle 316 that fits into one of one or more holes 318 on a second side 319 of the mobile device.

Open and closed configurations of the buckle-hole lock 310 may disconnect and/or connect circuit elements of the mobile device 312, thereby enabling and/or disabling systems and functions of the mobile device, or otherwise alter a state of the mobile device 312. For example, a conductive external surface of the buckle 316, when fit into a hole 318 with a corresponding exposed conductive element, may complete an electrical connection in to cause a wireless data system to be enabled or disabled.

FIG. 3C shows an example pin lock 320 in a mobile device 322. A first side 324 of the mobile device 322 includes a retractable pin 328 that fits into a lateral hole 330 defined in a second side 332 of the mobile device.

Open and closed configurations of the pin lock 320 may enable and/or disable systems and/or functions of the mobile device, or otherwise alter a state of the mobile device. For example, the pin 328, when in position in the lateral hole 330, may push out of the way another component, or exert pressure on another component, such that the systems and/or functions are enabled and/or disabled. For example, a movable conductor, a Faraday shield, or a sensed strain may be adjusted based on the position of the pin 328, the conductor position, Faraday shield position, or strain correspondingly (directly or indirectly) causing adjustment to another configuration of the mobile device.

FIG. 3D shows an example clasp lock 340 in a mobile device 342. A clasp 344 is configured to be pivoted from an open position to a closed position, where a closed position of the clasp 344 causes tension to be exerted on a body of the mobile device 342 to keep the clasp lock 340 and the mobile device 342 closed.

Open and closed configurations of the clasp lock 340 may disconnect and/or connect circuit elements of the mobile device 342, thereby enabling and/or disabling systems and/or functions of the mobile device 342, or otherwise alter a state of the mobile device 342. For example, a conductive portion 346 of the clasp 344, when pivoted into the closed position, may complete an electrical connection between two conductive elements 348a, 348b, disposed in the body of the mobile device 342, correspondingly enabling/disabling the systems and/or functions. As another example, the strain exerted upon a portion of the mobile device 342 by the clasp 344 in the closed configuration may be sensed (e.g., by a strain sensor) to cause the enabling/disabling of the systems and/or functions, or the strain may directly cause the enabling/disabling, e.g., by altering a mechanical or electrical property of the mobile device 342.

FIG. 3E shows an example spring lock 350 in a mobile device 352. A pin 354 is coupled to a spring 356. The pin 354 may be depressed by a button 358 such that a latch 355 can fit into an opening 357, where the latch 355 is held in place.

Open and closed configurations of the spring lock 350 may disconnect and/or connect circuit elements of the mobile device 352, thereby enabling and/or disabling systems and/or functions of the mobile device 352, or otherwise alter a state of the mobile device 352. For example, movement of the pin 354 may move a Faraday shield that enables/disables wireless functions, may change a strain applied to a strain-responsive element to enable and/or disable functions of the mobile device 352, etc.

FIG. 3F shows an example clasp lock 360 in a mobile device. A clasp 361 on a first side 362 of the mobile device may be passed through a hole 363 on a second side 364 of the mobile device and, subsequently, pivoted to latch into position in a closure 365. Internally, the closure 365 include a spring 366 that holds the clasp 361 in place. A release mechanism 367 (e.g., a button or switch) can be manipulated to release the clasp 361. In some implementations, instead of a spring 366, the clasp 361 fits into a second hole on the first side 362 of the mobile device, where the clasp 361 is held in place.

Open and closed configurations of the clasp lock 360 may disconnect and/or connect circuit elements of the mobile device, thereby enabling and/or disabling systems and/or functions of the mobile device, or otherwise alter a state of the mobile device. For example, a conductive portion of the clasp 361, when held in position in the closure 365, may complete an electrical connection that correspondingly enables/disables the systems and/or functions.

FIG. 3G shows an example combination lock 370 in a mobile device. A belt 372 integrated into a body of the mobile device loops around a bar 374 that may be inserted into a lock body 376 and locked in position therein. Adjustable dials 378 (e.g., number dials) may be adjusted by a user to lock and unlock the bar 374 from its position in the lock body 376, e.g., by setting a correct combination. When the bar 374 is unlocked, the belt 372 may be unlooped from around the bar 374 and the mobile device opened. Internal combination lock mechanisms known in the art may be used.

Adjustable dials, buttons, or other code-based locking mechanisms may be integrated into any one or more of the lock implementations described herein or into other lock implementations. For example, a mobile device may include an electronic keypad configured to release the clasp 344 from its locked position when a correct combination of numbers are entered into the keypad.

Open and closed configurations of the combination lock 370 may disconnect and/or connect circuit elements of the mobile device, thereby enabling and/or disabling systems and/or functions of the mobile device, or otherwise alter a state of the mobile device. For example, when the combination lock 370 is unlocked, a mechanical configuration of the mobile device may correspondingly be changed to enable and/or disable functions of the mobile device.

FIG. 3H shows an internal trap lock 380 in a mobile device. A clasp 381 on a first side 382 of the mobile device may be inserted into a hole 383 on a second side 384 of the mobile device and held therein by an anchor 385. An external button 386 may be pushed to move the anchor 385 and thereby release the clasp 381.

Open and closed configurations of the internal trap lock 380 may disconnect and/or connect circuit elements of the mobile device, thereby enabling and/or disabling systems and/or functions of the mobile device, or otherwise alter a state of the mobile device. For example, a conductive portion of the clasp 381, when locked in contact with a conductive portion of the anchor 385, may complete an electrical connection that correspondingly enables/disables the systems and/or functions, or the clasp, when closed or open, may correspond to a changed position of a mechanical element that enables/disables the systems and/or functions.

FIG. 3I shows a key lock 390 in a mobile device. A clasp 391 on a first side 392 of the mobile device may be inserted into a hole 393 on a second side 394 of the mobile device and held therein by an anchor (not shown). The second side 394 of the mobile device includes two dials 395 that are turnable by a user of the mobile device. In addition, a key passageway 396 is configured to receive a key 397 that moves pins 398.

In the example implementation shown in FIG. 3I, the dials 395 are blocked from turning unless pins 398 are moved by the correct key 397. When the key 397 is inserted and the pins 398 are shifted, the dials 395 are movable and may be turned to a predetermined configuration. For example, the dials 395 may show a series of numbers around their circumference, and the predetermined configuration may be a sequence of numbers exposed by the dials 395.

When the dials 395 are in the predetermined configuration, the clasp 391 may be removed from its locked position in the hole 393; otherwise, the clasp 391 is held in position in the hole 393.

FIG. 3I shows an implementation of a key lock that is operable by a key. However, keys (whether physical or electronic) may be implemented in combination with any one or more of the lock implementations described herein, or in other lock implementations.

In some implementations, an open/closed configuration of a lock corresponds to a blocking/non-blocking configuration, respectively, of a Faraday shield. For example, a movable mechanism of the lock may be coupled to a Faraday shield such that, when the lock is open, the Faraday shield blocks a wireless data system of the mobile device from sending/receiving signals, as described in more detail throughout this disclosure. For each of the lock implementations disclosed in reference to FIGS. 3A-3I, the basis by which a lock configuration enables and/or disables systems and/or functions of the mobile device may be electrical, mechanical (e.g., strain-based), or both electrical and mechanical. In some implementations, a strain or pressure sensor may determine a configuration of the lock and, in response, enable and/or disable systems and/or functions of the mobile device. The mechanisms and configurations disclosed in reference to FIGS. 3A-3I are non-limiting example implementations, and features of each may be combined with one another without departing from this disclosure.

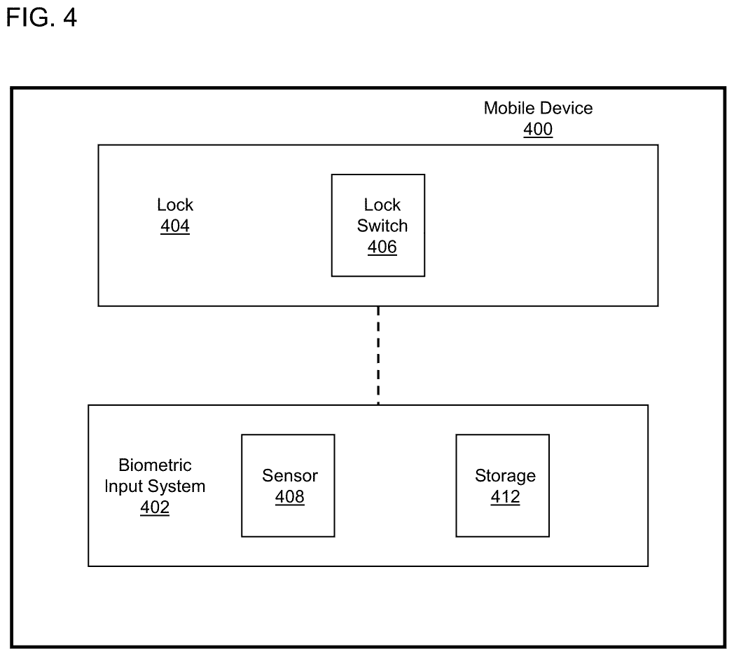

In some implementations, a lock is configured to open and/or close based on a biometric authentication process. FIG. 4 shows a schematic of a mobile device 400 including a biometric input system 402 and a lock 404. The lock 404 may include features from any one or more of the locks described in reference to FIGS. 3A-3I and, additionally, includes a lock switch 406 coupled to the biometric input system 402.

The lock switch 406, and lock switches included in locks according to various implementations of this disclosure, are configured to hold the lock 404 into one or both of a locked (closed) position or an unlocked (open) position or state. The lock switch 406 may include one or a combination of a moveable anchor, bar, pin, gear, ratchet, or other mechanism that can hold the lock 404 in position. In some implementations, the lock switch 406 includes an electronic switch between a closed state and an open state, e.g., an electronic storage storing an indicator of the current state.

The biometric input system 402 includes one or more sensors 408, e.g., one or more of a fingerprint pressure sensor, a camera (e.g., for facial authentication, retinal/iris authentication, and/or fingerprint detection), a microphone (e.g., for voiceprint authentication), or another biometric sensor. The biometric input system 402 also includes a storage 412 storing authentication information for one or more users, e.g., biometric information programmed into the device based on biometric input from the one or more users. In some implementations, the storage 412 is not specific to the biometric input system 402 but rather is included in another storage of the mobile device 400 or in a cloud-based storage accessible by a wireless data system of the mobile device.

After a user inputs biometric information into the sensor 408, the biometric input system 402 (e.g., by one or more processors) compares the input biometric input information to the pre-configured authentication information. If there is a match, then the biometric input system 402 controls the lock switch 406 (e.g., by movement of an actuator) to switch a state of the lock 404. As described throughout this disclosure, because, in some implementations, a state of the lock 404 corresponds to one or more enabled/disabled systems/functionalities of the mobile device 400, the biometric input system 402 can correspondingly enable/disable these systems/functionalities by switching of the state of the lock 404.

In some implementations the biometric input system 402 is configured to activate and/or deactivate one or more other systems of the mobile device 400 besides the lock 404. For example, the biometric input system 402 may, upon receiving matching or non-matching biometric information, close or open electrical switches included in wireless data systems of the mobile device 400 to enable/disable functionalities thereof. In some implementations, the biometric input system 402, upon receiving matching or non-matching biometric information, is configured to physically move a Faraday shield to permit or block wireless signal transfer to/from wireless data systems of the mobile device 400, as described in more detail throughout this disclosure. In some implementations, the biometric input system 402, upon receiving non-matching biometric information, is configured to alert an anti-breach system to an unauthorized event, as described in more detail throughout this disclosure.

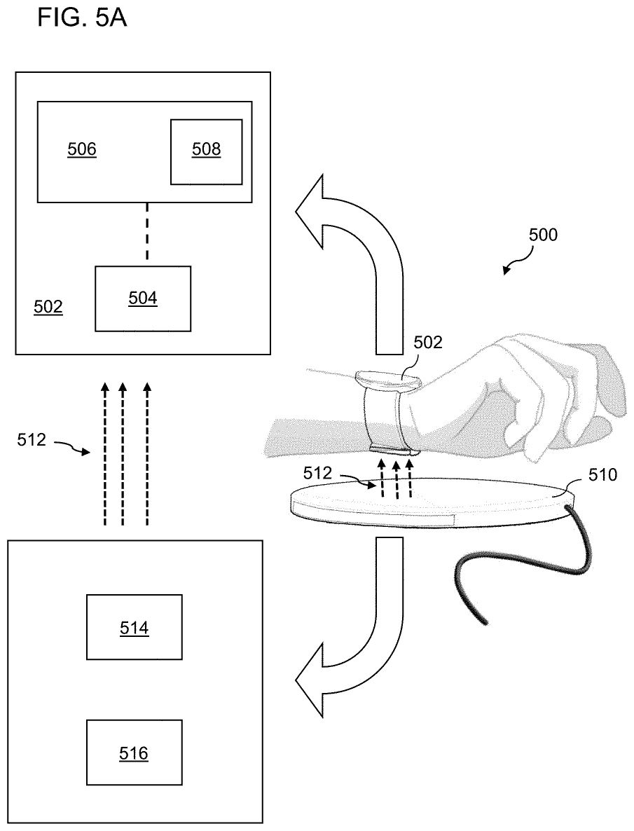

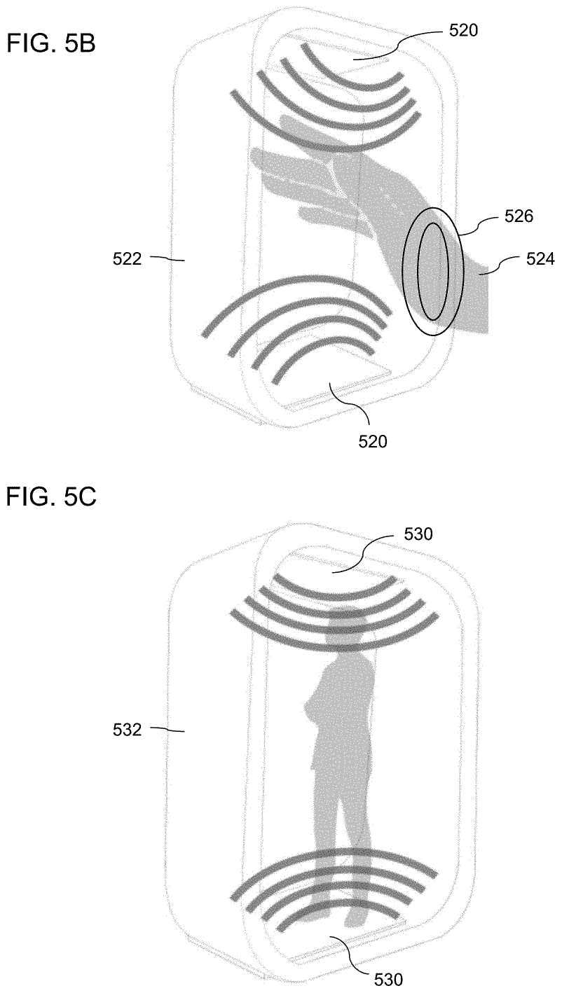

In some implementations, a lock is configured to open and/or close based on signals from a base station. FIG. 5A shows a secure system 500 including a mobile device 502, the mobile device 502 including a wireless data system 504 and a lock 506. The lock 506 may include features from any one or more of the locks described in reference to FIGS. 3A-3I and includes a lock switch 508 coupled to the wireless data system 504.

The secure system 500 also includes a base station 510. The base station 510 includes a second wireless data system 514 and an optional power provision system 516.

The wireless data system 504 and the base station 510 are configured to receive and/or transmit signals between each other, either in one direction or in both directions. Based on signals received from the base station 510, the lock switch 508 switches to open/close the lock 506. FIG. 5A is described in further detail below.

In some implementations, the base station 510 is a mobile electronic device, e.g., a smartphone, a laptop, or a tablet. For example, a user may download an application onto their smartphone to enable the smartphone to serve as a base station for one or more mobile devices as described throughout this disclosure. Existing functionalities of the mobile electronic device (e.g., RFID, Bluetooth, wireless charging, etc.) may be repurposed to perform the base station-related functions described herein.

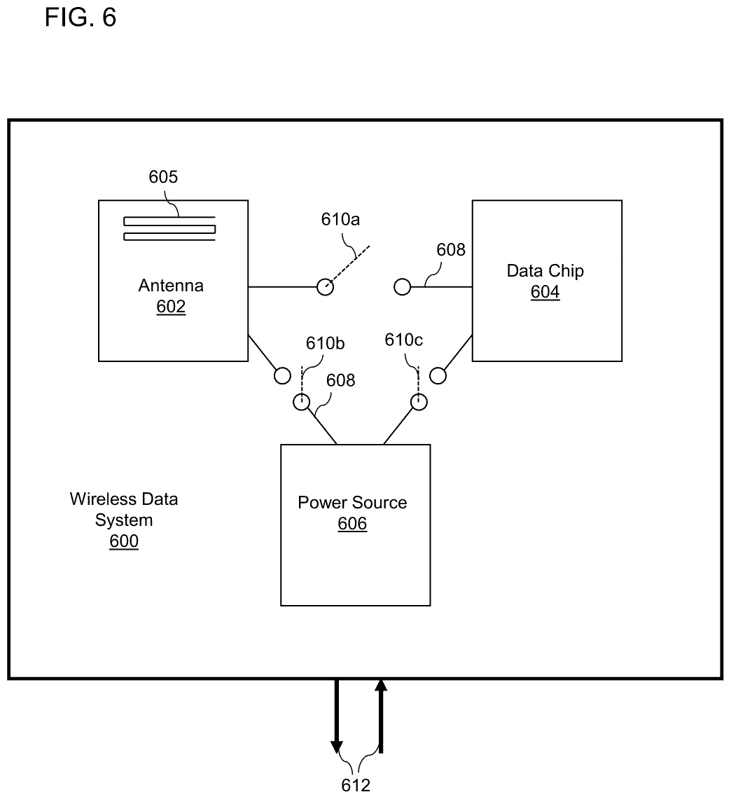

FIG. 6 shows a wireless data system 600 included in a mobile device, e.g., the wireless data system 504 or another wireless data system included in an implementation according to this disclosure. A single mobile device may include zero, one, or multiple wireless data systems.

The wireless data system 600 includes one or more antennas 602, one or more data chips 604, and one or more power sources 606, e.g., a battery. Some wireless data systems do not include each of these elements. For example, in some implementations a wireless data system is passive and does not include a power source.

At least some components of the wireless data system 600 are linked by electrical interconnects 608, e.g., wires, traces, or other conductive elements. One or more paths along the electrical interconnects 608 (e.g., paths between respective components) may include an electrical switch 610a, 610b, 610c, which may be, in various implementations, an electronic switch (e.g., a digital switch including a transistor) or a physical switch that is connected or disconnected based on one or more movable conductors. Control of the electrical switches 610 makes and breaks connections between the components of the wireless data system 600.

In some implementations, the wireless data system 600 is electrically coupled to other components of the mobile device (e.g., the anti-breach system, the lock, movable components, and/or other wireless data systems) by coupling components 612, e.g., wires, traces, or other conductive elements. The coupling components 612 can also represent shared physical components, e.g., a movable portion of a lock that also acts as an electrical switch in the wireless data system 600.

In some implementations, an electrical switch included in a wireless data system is integrated together with a lock. For example, as described in reference to FIGS. 3A-3I, conductive portions of a lock may form a portion of an electrical switch, such that the physical switch is open/closed based on a state of the lock. For example, in some implementations, when the lock is open, an electrical connection is broken between the antenna 602 and the data chip 604, e.g., electrical switch 610a is open because portions of the lock are not in contact with one another. Therefore, antenna 602 is physically prevented from transmitting data from the data chip 604. This provides a secure data protection functionality that cannot be bypassed except by physical attack. In some implementations, an electrical switch is closed when a corresponding lock is open.

In some implementations, an electrical switch is included in an anti-breach system, as described in further detail throughout this disclosure. In some implementations, an electrical switch is included in a user control, e.g., a physical, user-accessible control, as described in further detail throughout this disclosure.

The antenna 602 may be configured to receive wireless signals, to transmit wireless signals, or to both receive and transmit wireless signals. In some implementations, the antenna 602 includes a metal or otherwise conductive film 605 (e.g., a carbon film) disposed on a dielectric or otherwise insulating substrate. For example, the antenna 602 may include a meandering conductive film 605 having a thickness between 1 μm and 100 μm, or thicker. The substrate may be, for example, a printed circuit board or a flexible substrate (e.g., plastic or paper).

The antenna 602 may be configured (e.g., by a length, width, thickness, material, and/or shape of conductive film 605) to send and/or receive signals in various wavelength ranges, depending on the implementation. In various implementations, the antenna 602 is configured to send and/or receive signals having a frequency between 100 kHz and 10 GHz, between 120 kHz and 140 kHz, between 13.5 MHz and 13.6 MHz (e.g., about 13.56 MHz), between 430 and 960 MHz, between 860 MHz and 960 MHz, between 865 MHz and 870 MHz, between 900 MHz and 930 MHz, between 2.4 GHz and 2.485 GHz, between 2.45 GHz and 5.8 GHz, or another frequency range.

In some implementations, the wireless data system 600 includes multiple antennas 602, each antenna 602 configured to send and/or receive signals from a different respective frequency range.

In some implementations, the wireless data system 600 is configured to receive and/or transmit other types of signals, e.g., Wi-Fi signals and/or cellular signals, which may allow for internet access by the mobile device.

The data chip 604 includes one or more integrated circuits that process signals received by and/or transmitted from the antenna 602. For example, in some implementations, the data chip 604 is configured to modulate, demodulate, encode, and/or decode signals received by and/or sent by the antenna 602, e.g., to convert received signals into interpretable data and convert data stored on the data chip 604 into signals sent by the antenna 602.

The data chip 604 is configured to perform modulation, demodulation, encoding, and/or decoding on signals according to one or more protocols. For example, in some implementations the data chip 604 is configured to provide and/or receive Bluetooth signals. In some implementations, the data chip 604 is configured to provide and/or receive RFID signals, e.g., ISM-band signals. In some implementations, the data chip 604 is configured to provide and/or receive multiple types of signal.

In some implementations, the data chip 604 includes “hard-coded” analog circuit elements, e.g., circuits configured to filter, modulate, amplify, or otherwise process electrical signals in a predetermined way. In some implementations, the data chip 604 includes logic elements, e.g., a microprocessor or a field programmable gate array (FPGA). The data chip 604 may include both hard-coded circuit elements and logic elements, e.g., a received Bluetooth signal may be demodulated by an analog circuit, and the demodulated signal may then be passed to a digital circuit element for further processing. Logic elements of the data chip 604 may receive instruction signals from other elements of the mobile device and corresponding alter a function of the wireless data system 600, e.g., enable or disable the wireless data system 600, change a signal emitted by the wireless data system 600, etc. Instructions signals, in some implementations, are sent based on a lock state, e.g., a sensed mechanical configuration of a lock may result in a corresponding instruction signal being sent to a wireless data system to change a functionality of the wireless data system. Instruction signals may be sent by another wireless data system based on a signal received at the other wireless data system.

The data chip 604 may include storage, for example, memory (e.g., RAM) and/or persistent storage, either or both of which may store instructions executable by the data chip to perform operations.

In some implementations, the wireless data system 600 is wholly or partially passive. Rather than relying solely on a power source for power, the wireless data system 600 is powered at least partially by received wireless signals, according to known RFID and other methods.

Besides signal provision/reception, the data chip 604 may be configured to perform other operations. For example, the data chip 604 may be configured to identify control signals embedded in received wireless signals and perform corresponding operations. Such operations may include, for example, activating and/or deactivating systems and/or functions of the mobile device using the coupling components 612.

For example, referring back to FIG. 5A, the wireless data system 504 may be configured to receive a wireless signal 512 sent by the second wireless data system 514 of the base station 510. The wireless signal 512 indicates that the lock 506 should be opened or closed. For example, the wireless signal may include a first ID that matches a device ID of the mobile device 502, the device ID being stored on the wireless data system 504. The wireless data system 504 is configured to extract the first ID from the wireless signal, match it against the device ID, and, upon finding a match, send a signal to the lock switch 508 to cause the lock 506 to open or close, e.g., by actuating a component of the lock 506. As another example, the wireless signal 512 may include an ID of the base station 510 that is compared against a stored ID of the base station that the wireless data system 504 is pre-programmed to recognize. In some implementations, there may be no ID-matching; rather, an encoded “open” or “close” instruction is extracted from the wireless signal 512 by the wireless data system 504, which correspondingly controls the lock switch 508. Other implementations of open/close signals are also within the scope of this disclosure.

Secure systems in which a lock of a mobile device is controlled, at least partially, by wireless signals from a base station can provide security advantages. For example, in some implementations the wireless signal 512 is a short range wireless signal, e.g., an RFID signal. Upon entering a secure facility, a visitor has the mobile device 502 attached to their wrist and locked in place. The wireless data system 504 is used to track the visitor as they move throughout the secure facility. The visitor cannot remove the mobile device 502 themselves; rather, they must remove it when leaving the secure facility by moving the mobile device 502 near the base station 510 to receive the wireless signal 512 instructing the lock 506 to open.

Other implementations of the base station 510 are also within the scope of this disclosure. For example, as shown in FIG. 5B, in some implementations a base station 520 is integrated into an enclosure 522. A user 524 may insert a mobile device 526 (e.g., a bracelet) into the enclosure 522 to activate functions of the mobile device 526, e.g., switch a configuration of a lock.

As shown in FIG. 5C, in some implementations a base station 530 is integrated into a larger area such as a room 532 or other space. In some implementations, a network of base stations are distributed throughout a facility.

Many other configurations and functions of the wireless data system 600 are within the scope of this disclosure. For example, in some implementations, the wireless data system 600 is configured to emit tracking signals, either actively or upon reception of a received beacon signal (e.g., based upon identifying an embedded indicator in the received beacon signal). These tracking signals are received by base stations in a vicinity of the mobile device and can be used to track the mobile device, e.g., as the mobile device is carried by a user throughout a facility.

In some implementations, the wireless data system 600 is configured to receive a wireless proximity signal emitted by one or more base stations. If the wireless proximity signal is not received, the mobile device may have been carried out of a proximity of the one or more base stations, e.g., out of a secure facility. This failure to remain in the proximity of the one or more base stations is an unauthorized event that may indicate a security breach. Therefore, based on a failure to receive the wireless proximity signal (e.g., a failure to receive the wireless proximity signal over a predetermined length of time), the wireless data system 600 may trigger a response operation by an anti-breach system of the mobile device, as described in more detail throughout this disclosure. The wireless proximity signal may be identified by the wireless data system 600 based on an embedded indicator in the wireless proximity signal.

In some implementations, the wireless data system 600 is configured to receive a wireless alert signal and, based on receiving the wireless alert signal (e.g., based on identifying an embedded indicator in the wireless alert signal), trigger a response operation by an anti-breach system of the mobile device, as described in more detail throughout this disclosure. The wireless alert signal may be transmitted throughout an area in order to quickly “lock down” (e.g., disable) all mobile devices in the area, or for another reason. The base station 510 may be configured to transmit the wireless alert signal.

In some implementations, the wireless data system 600 is configured to cause one or more operations by an external device, e.g., unlocking or locking a door or external lock, causing machinery to start, stop, or perform another operation, etc. The mobile device is moved into a certain proximity of the external device and either actively transmits an instruction signal or receives a wireless signal from the external device that causes the wireless data system 600 to transmit the instruction signal, e.g., upon matching an embedded ID within the wireless signal with a stored ID associated with the external device.

In some implementations, the wireless data system 600 is configured to receive data from an external device (e.g., a base station), store the data in a storage of the mobile device, and later upload the data to the same or another external device. A mobile device according to this disclosure therefore may serve as a secure, trackable means of data transfer.

In some implementations, the wireless data system 600 is configured to receive a function switch signal and, based on receiving the function switch signal (e.g., based on identifying an embedded indicator in the function authorization signal), enable and/or disable one or more functions of the mobile device. For example, a first function switch signal may authorize a data transfer function performed by a second wireless data system of the mobile device, and, in response to receiving the first function switch signal, the wireless data system 600 may switch an electrical switch of the second wireless data system, e.g., to interconnect an antenna of the second wireless data system with a data chip of the second wireless data system. A base station may be configured to transmit the function switch signal.

As another example, a second function switch signal may instruct the disabling of a third wireless data system. In response to receiving the second function switch signal, the wireless data system 600 is configured to physically adjust a Faraday shield of the mobile device to block wireless transmission to/from the third wireless data system, as described in more detail throughout this disclosure.

Other configurations and implementations of the wireless data system 600 are also within the scope of this disclosure.

A given wireless data system may be configured to perform one or more functions, e.g., in response to corresponding one or more received wireless signals. In some implementations, a mobile device includes multiple wireless data systems, each wireless data system performing one or more functions.

As noted above, in some implementations the base station 510 includes a power provision system 516. The power provision system 516 may perform wired and/or wireless power transfer to the mobile device 502. In some implementations, the mobile device 502 is configured such that certain functions/systems of the mobile device 502 are disabled when the mobile device is charging. For example, a power reception system of the mobile device 502 may be configured such that the power reception system is enabled only when the lock 506 is open, and, in addition, the lock 506 being open might cause one or more other systems of the mobile device 502 to be disabled, as described throughout this disclosure.

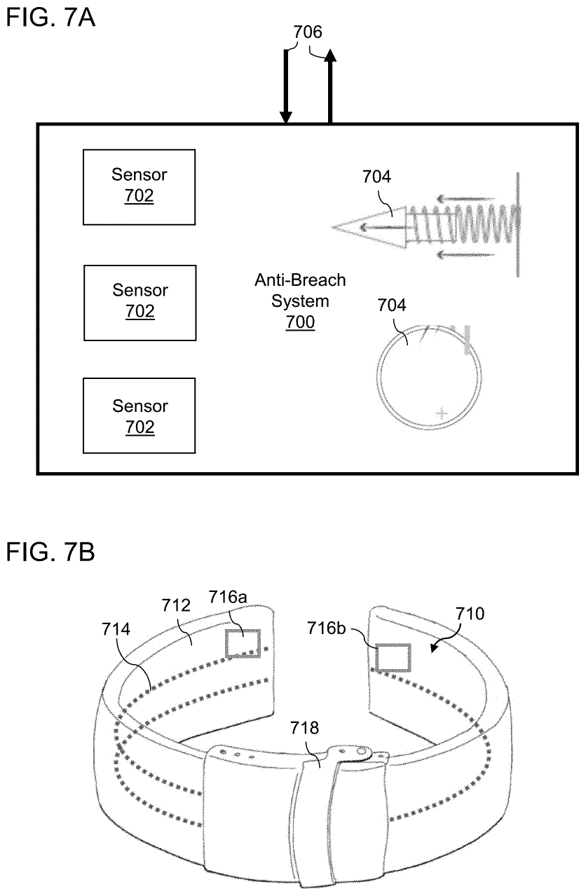

Some implementations of mobile devices described herein include an anti-breach system that enhances the security of the mobile device. FIG. 7A shows a schematic of an anti-breach system 700 included in a mobile device. The anti-breach system 700 includes one or more sensors 702, one or more response mechanisms 704 configured to perform response operations based on readings by the one or more sensors 702, and, in some implementations, electrical connections 706 to other systems of the mobile device. The anti-breach system 700 is typically not localized to a particular portion of the mobile device; rather, portions of the anti-breach system 700 may be distributed throughout the mobile device to detect and respond to unauthorized events throughout the mobile device.

The sensors 702 are configured to detect physical breaches of aspects of the mobile device. These physical breaches are examples of unauthorized events; however, as described throughout this disclosure, unauthorized events may alternatively or additionally include non-physical breaches, e.g., reception of particular wireless signals.

In various implementations, the sensors 702 may include a force sensor, a strain sensor, an electrical continuity sensor, a touch sensor, or a combination thereof.

FIG. 7B shows an example of an electrical continuity sensor 710 embedded in a mobile device 712. The electrical continuity sensor 710 includes a strip of conductive material 714 extending along a length of the mobile device 712 and one or more electrical detectors 716a, 716b configured to check whether an electrical connection along the strip 714 is intact, e.g., to check whether the electrical detectors 716a, 716b are electrical connected to one another. An attempt to breach the mobile device 712 by, for example, cutting through the lock 718 of the mobile device 712 breaks the electrical continuity of the strip 714 and constitutes an unauthorized event to which the response mechanisms 704 respond with response operations.

For force sensors and strain sensors, an unauthorized event may include a detected force or strain that is above a predetermined threshold force or strain. For example, the electrical continuity sensor 710 may alternatively, or additionally, be a mechanical pressure or strain sensor configured to detect local or device-wide pressure/strain and, in response to a pressure or strain above or below a predetermined threshold, initiate response operations.

For touch sensors, an unauthorized event may include a detected touch. For example, a touch sensor may be included inside the mobile device such that the touch sensor is not contacted during normal authorized use. However, a breach of the mobile device may cause the touch sensor to be contacted, triggering response operations.

In some implementations, an unauthorized event may be indicated by another system of the mobile device and indicated to the anti-breach system 700 by the electrical connections 706. For example, a received alert signal or a failure to receive a proximity signal may cause a wireless data system to transmit an indication of an unauthorized event to the anti-breach system 700. An incorrect code entered into a lock mechanism may cause the lock to transmit an indication of an unauthorized event to the anti-breach system 700. A non-matching biometric input may cause the biometric input system to transmit an indication of an unauthorized event to the anti-breach system.

Upon notice of an unauthorized event, the response mechanisms 704 perform one or more response operations, e.g., based on an instruction signal sent by the sensors 702 or by another component that causes actuation or other movement of a physical component. Typically, these response operations are configured to irreversibly damage one or more portions of the mobile device in order to maintain the security of data stored on the mobile device or in order to prevent the mobile device from being misused. However, in some operations the damage caused by response operations is reversible, e.g., a broken electrical connection that can be repaired to recover data still stored on the mobile device, a reconfigured circuit that can be returned to its original configuration, a moved Faraday shield that can be returned to its original position, or a reprogrammed or reconfigured wireless data system circuit that can be restored to its previous state upon reception of another signal.

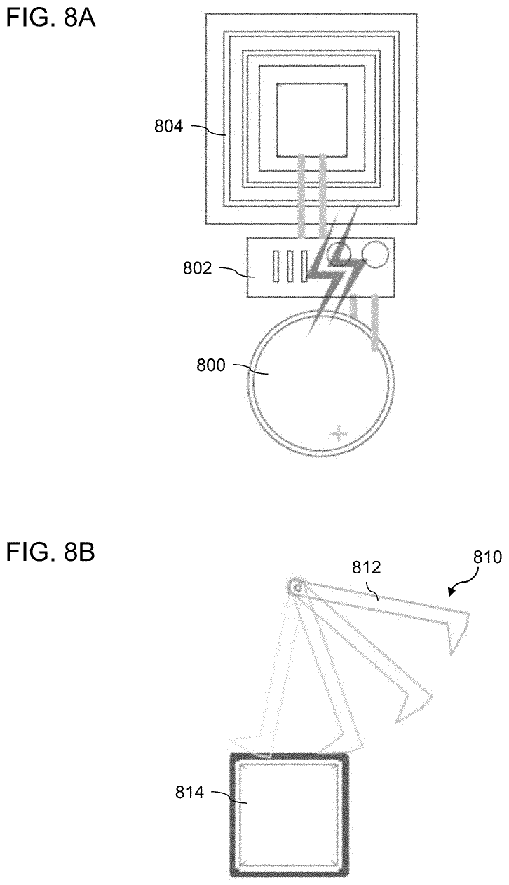

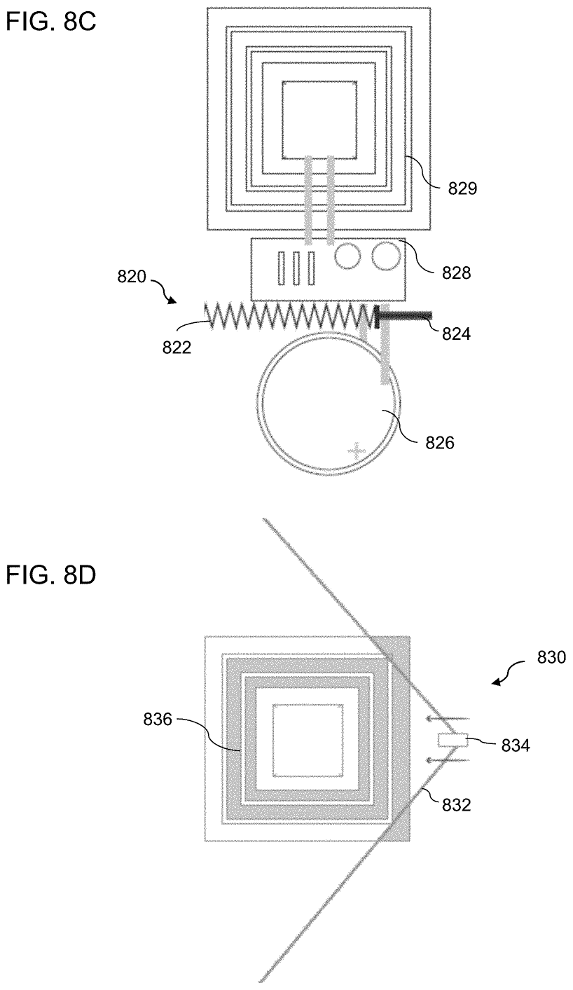

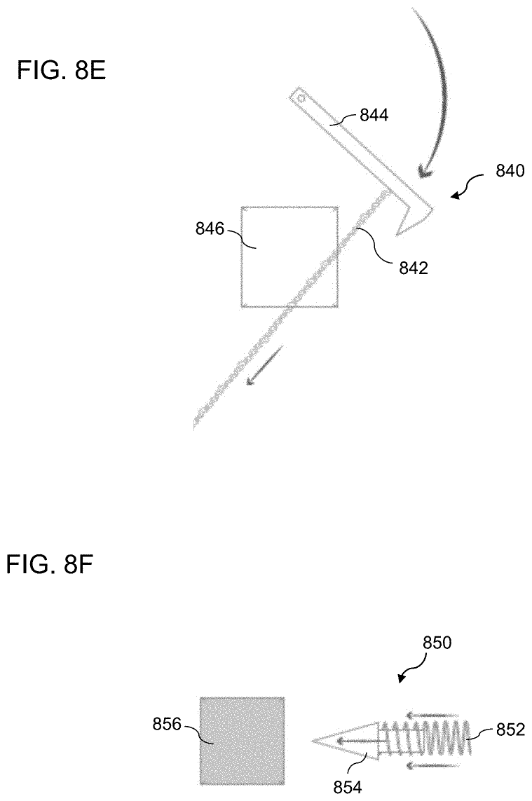

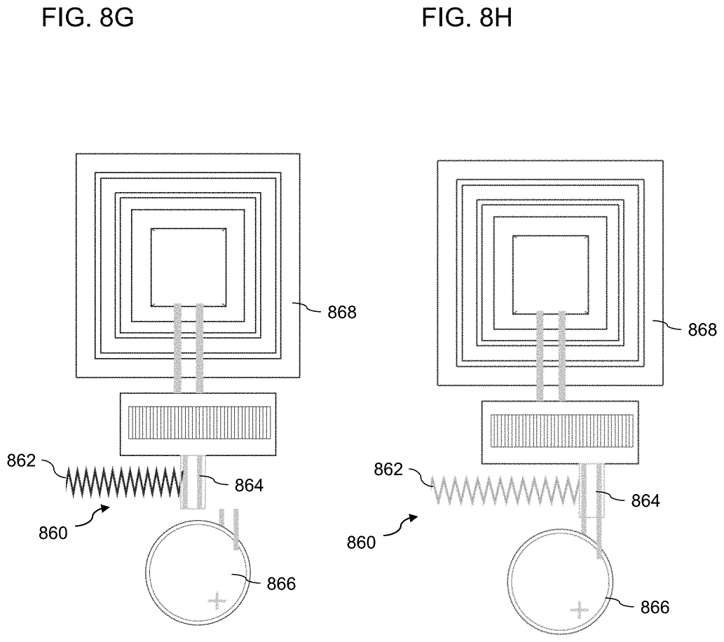

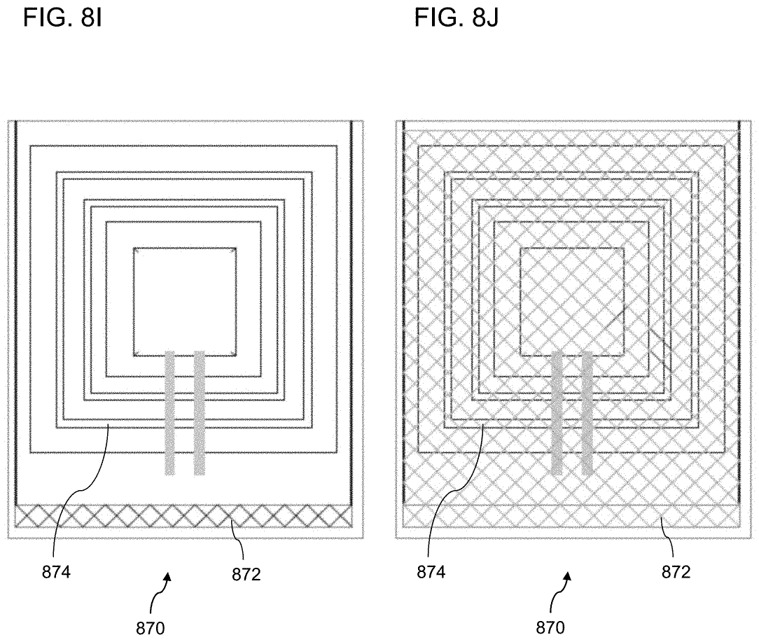

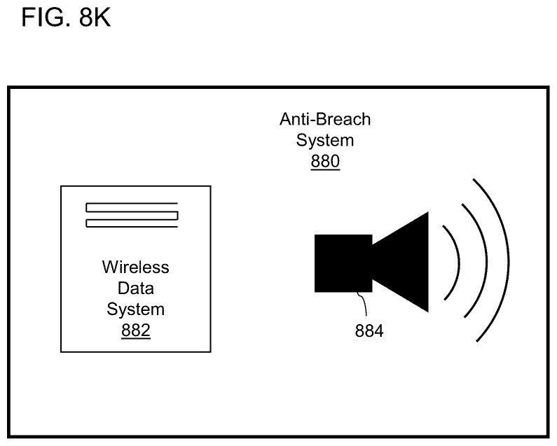

FIG. 8A shows an example overcharge response operation. In response to the detection of an unauthorized event, an electrical connection is altered between a battery 800 and a data chip 802 connected to an antenna 804. For example, an electrical response mechanism of an anti-breach system may send a signal to produce an electrical short between the battery 800 and the data chip 802, or a movable conductor of the anti-breach system may be moved to produce the electrical short. An overcharge caused by the battery 800 damages the data chip 802, preventing the data chip 802 from being used for future, potentially compromised operations.

FIG. 8B shows an example chemical response operation. An anti-breach system 810 includes a projectile arm 812 and a chemical container 814 containing a corrosive or otherwise damaging chemical, e.g., an acid, white phosphorous, or an oxidizer. When an unauthorized event is detected, the projectile arm 812 is moved or released to damage the chemical container 814 and release the chemical inside, which subsequently damages a portion of the mobile device. For example, the chemical container 814 may be positioned in proximity to (e.g., in contact with, on, or under) a wireless data system such that the released chemical damages a data chip of the wireless data system.

FIG. 8C shows an example contact-severing response operation. An anti-breach system 820 includes a spring 822 and a cutting piece 824 coupled to the spring 822. When an unauthorized event is detected, the spring 822 is released to cause the cutting piece 824 to sever an electrical contact between a battery 826 and a data chip 828, preventing the antenna 829 from sending/receiving signals using a powered data chip 828.

FIG. 8D shows an example spring-loaded response operation. An anti-breach system 830 includes a spring 832 and a cutting piece 834 coupled to the spring 832. When an unauthorized event is detected, the spring 832 is released to cause the cutting piece 834 to damage an antenna 836.

FIG. 8E shows another example spring-loaded response operation. An anti-breach system 840 includes a spring 842 and a projectile arm 844 coupled to the spring 842. When an unauthorized event is detected, the spring 842 is released to cause the projectile arm 844 to impact a data chip 846, damaging the data chip 848.

FIG. 8F shows another example spring-loaded response operation. An anti-breach system 850 includes a spring 852 and a pointed projectile 854 coupled to the spring 852. When an unauthorized event is detected, the spring 852 is released to cause the pointed projectile 854 to directly impact a data chip 856, damaging the data chip 856.

FIGS. 8G-8H show two configurations corresponding to an electrical reconfiguration response operation. An anti-breach system 860 includes a spring 862 and electrical contacts 864 coupled to the spring 862. When an unauthorized event is detected, the spring 862 is released, the electrical contacts 864 contact a battery 866 (as shown in FIG. 8H), and a resulting electromagnetic discharge damages a portion of the wireless data system 868.

FIGS. 8I-8J show two configurations corresponding to a Faraday shield response operation. An anti-breach system 870 includes a Faraday shield 872 that, as shown in FIG. 8I, normally does not block signal reception/transmission by an antenna 874. However, when an unauthorized event is detected, the Faraday shield 872 is moved into place to cover the antenna 874 (e.g., translated or rotated into place), blocking the signal reception/transmission and preventing the antenna 874 from being used to perform wireless signal operations, as described in more detail throughout this disclosure.

FIG. 8K shows an alert-based response operation. An anti-breach system 880 includes a wireless data system 882 (e.g., a wireless data transmission system) and an alert component 884, e.g., a speaker, a vibrator, a light source, or another component that causes a noticeable response. When an unauthorized event is detected, the wireless data system 882 is configured to emit a wireless signal indicative of the unauthorized event. The wireless signal may be received by another device (e.g., a base station) to trigger appropriate actions, e.g., an alert of a theft or an attempted breach. In addition, or alternatively, in response to the unauthorized event, the alert component 884 is configured to cause a noticeable response (an alert indicator) to alert a user of the mobile device or other users in the vicinity to detection of the unauthorized event. For example, a user leaving a secure facility with a mobile device may cause the mobile device to emit an audible alarm sound until the mobile device is returned.

The wireless data system 882 and alert component 884 need not be included together in anti-breach systems; some implementations of anti-breach systems include only one or the other.

Other implementations of anti-breach systems are also within the scope of this disclosure. For example, an anti-breach system may include any or all of the components described herein with respect to different implementations of anti-breach systems.

In some cases, it may be desirable to allow a user to active/de-activate systems/functions of a mobile device on-demand, and to make the de-activation secure such that a de-activated is not unintentionally used. In some implementations, activation/de-activation may be performed purely electronically. For example, a mobile device may include a touchscreen and associated computing elements by which a user may electronically activate/de-active systems/functions.

However, electronic activation/de-activation may sometimes be insecure. For example, eavesdropping, cloning, and spoofing techniques may cause de-activated systems to be utilized (e.g., read out) by hackers.

Therefore, some implementations of mobile devices according to the present disclosure include physical, user-accessible controls that physically enable/disable systems/functions of the mobile device by moving components of the mobile device, such that unintentional or nefarious use of the systems/functions is physically prevented.

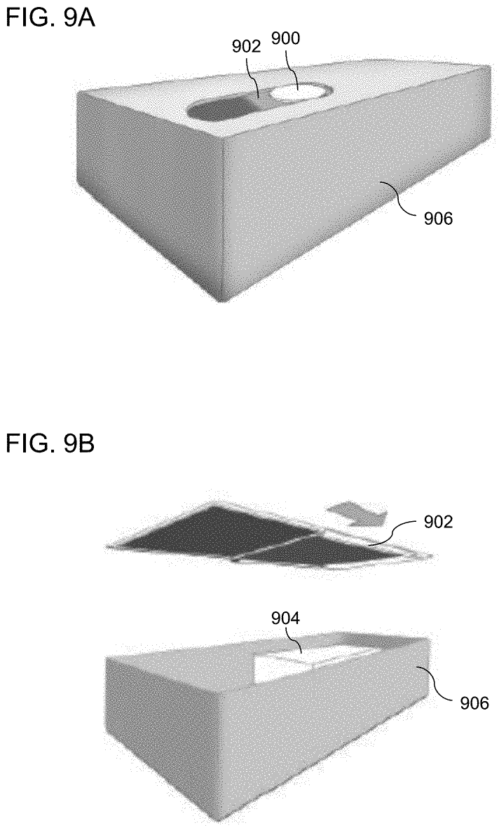

FIGS. 9A-9B show an example user-configurable control that activates/deactivates an associated wireless data system. A user-accessible slider 900 is coupled to a Faraday shield 902 and arranged near a wireless data system 904 embedded inside a mobile device 906. Depending on a position of the slider 900, the Faraday shield 902 either does not cover the wireless data system 904 or (as shown in FIG. 9B) does cover the wireless data system 904. When the Faraday shield 902 covers the wireless data system 904 (e.g., is interposed between an antenna of the wireless data system and external devices, and/or covers an opening in the mobile device 906 that otherwise exposes the antenna of the wireless data system 904), the wireless data system 904 is prevented from sending and receiving signals, securely preventing its misuse.

For example, a user may briefly move the slider 900 to expose the wireless data system 904 and download data. After the data is downloaded, the user moves the slider to electromagnetically block the wireless data system 904 and thereby prevent potential eavesdroppers from wirelessly probing the wireless data system 904.

As noted above, in some implementations a Faraday shield is coupled to a lock. For example, the slider 900 may be mechanically coupled to a lock such that, when the lock is open, the slider 900 necessarily covers the antenna of the wireless data system 904, disabling the wireless data system 904.

In various implementations, the Faraday shield may take a variety of forms. For example, the Faraday shield may include a screen (e.g., a substantially planar screen) or an enclosure (e.g., a cage or box). The Faraday shield may include one or more metals, a conductive carbon material, cellulose, a composite shielding material, a dielectric mirror, graphite/graphene, a conductive polymer, or another electromagnetic shield material.

Besides movable Faraday shielding components, fixed Faraday shielding components may be included, e.g., to surround a wireless data system except for where a movable Faraday shield can block/allow access. In some implementations, a shell of the mobile device is itself a Faraday shield or includes Faraday-shielding portions. In some implementations, an internal Faraday cage (constructed of an electromagnetic shield material) is enclosed within the shell.

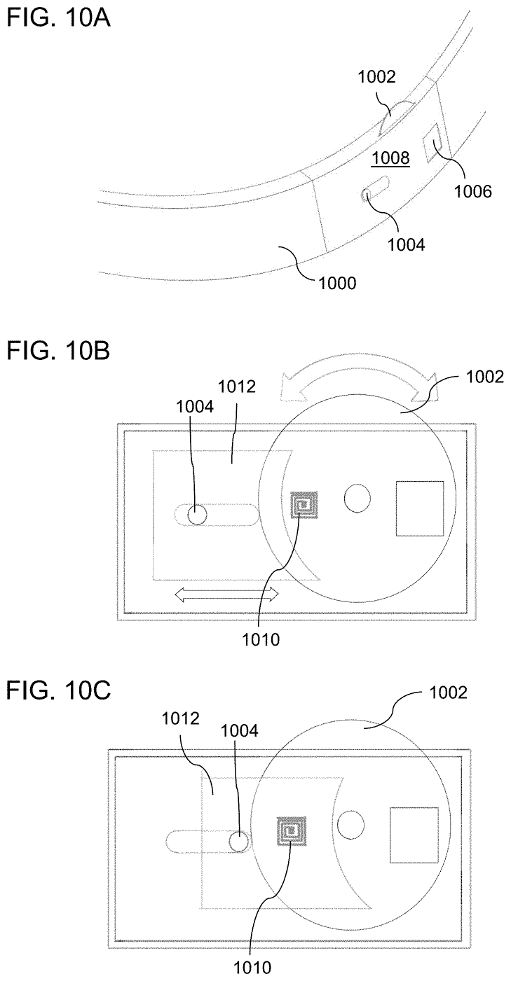

FIGS. 10A-10C show another example of a user-configurable control. A mobile device 1000 includes a user-accessible dial 1002, a user-accessible slider 1004, and an opening 1006. In addition, a shell 1008 of the mobile device 1000 acts as a Faraday shield, e.g., blocks wireless electromagnetic signals. The dial 1002 is mechanically coupled to a wireless data system 1010 (e.g., to an antenna of the wireless data system 1010 that is disposed on the dial) so as to, when rotated, move the wireless data system 1010 into and out of alignment with the opening 1006. When the wireless data system 1010 is aligned with the opening 1006, the wireless data system 1010 may transmit and receive wireless signals through the opening 1006. Otherwise, the wireless data system 1010 is securely prevented from performing wireless operations.

In addition, in this implementation, the slider 1004 is mechanically coupled to a Faraday shield 1012. As shown in FIG. 10C, the slider 1004 may be moved so as to cause the Faraday shield 1012 to cover the wireless data system 1010, preventing the wireless data system 1010 from performing wireless operations. This implementation therefore provides two-layered protection with two distinct user controls.

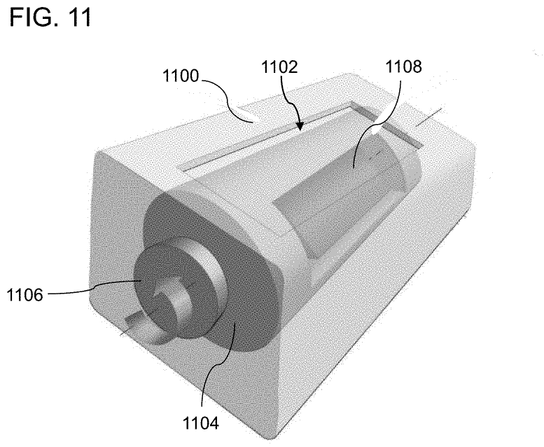

FIG. 11 shows another example of a user-configurable control. A Faraday cage 1100 defines an opening 1102. A rotatable axle 1104 is coupled to a user-accessible dial 1106, and a wireless data system 1108 is integrated into the axle 1104 (e.g., disposed on the axle 1104) so as to rotate with the axle 1104 upon rotation of the dial 1106. When the wireless data system 1108 is aligned with the opening 1102, the wireless data system 1108 may transmit and receive wireless signals through the opening 1102. Otherwise, the wireless data system 1108 is securely prevented from performing wireless operations.

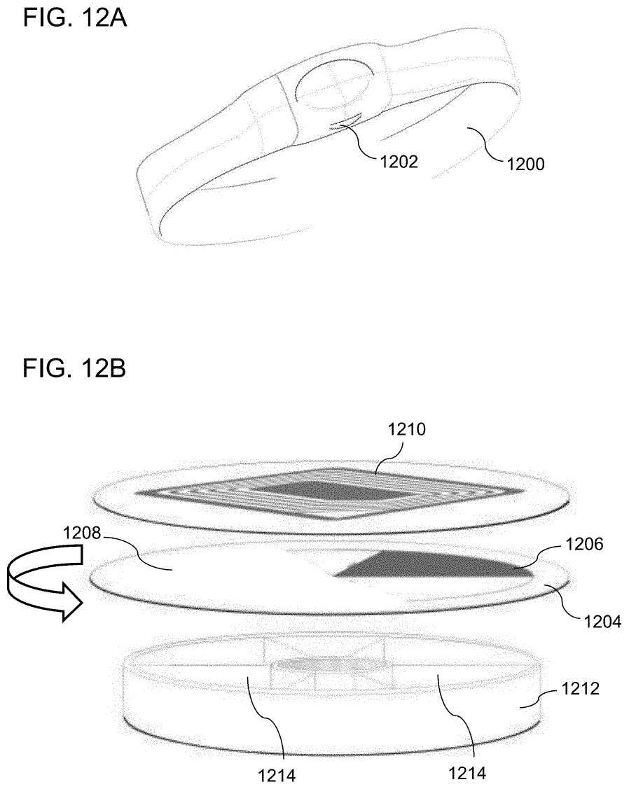

Some implementations of a user-configurable control do not, or need not, include a movable Faraday shielding component. FIGS. 12A-12B show another example of a user-configurable control. A mobile device 1200 includes a user-accessible dial 1202. Internally, the dial 1202 is part of a rotating circuit closure disk 1204 that includes a circuit closure portion 1206 (e.g., including one or more conductive elements) and a circuit opening portion 1208. The circuit closure disk 1204 is disposed between an antenna 1210 and a chip container 1212 that includes multiple different data chips (not shown) disposed in respective recesses 1214.

The multiple different data chips are arranged circumferentially around the chip container 1212. When the circuit closure disk 1204 is rotated, the circuit closure portion 1206 completes an electrical connection between a data chip immediately below the circuit closure portion 1206 and the antenna 1210, while the other data chips are disconnected. The data chip that is connected to the antenna 1210 can then perform signal operations using the antenna 1210.

Because each data chip is configured to perform one or more functions that may be different from one or more functions performed by the other data chips, rotation of the dial 1202 represents a selection of a subset of functions performable using the mobile device 1200. Other, unselected functions are physically prevented from being performed, because the data chips that would perform the unselected functions are electrically disconnected from the antenna 1210.

Other analogous user-configurable controls are within the scope of this disclosure. For example, other user-accessible mechanisms may be used to make and/or break electrical connections between internal components of a mobile device in order to activate a subset of functions of the mobile device. For example, a user-accessible button may control an electrical switch between a power source and a data chip, thereby enabling/disabling powered operations of the data chip.

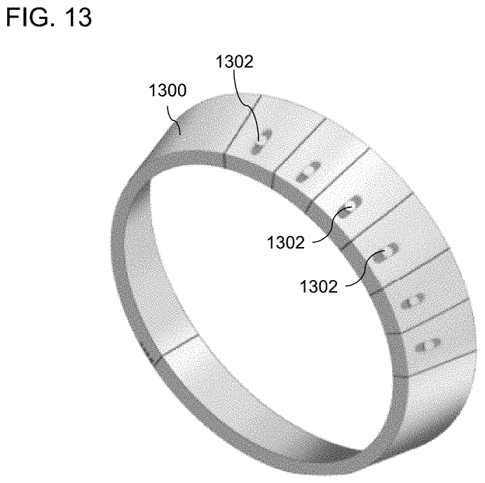

FIG. 13 shows another example of a user-configurable control. A mobile device 1300 includes a plurality of sliders 1302 coupled to respective Faraday shields (not shown), as described in reference to FIGS. 9A-9B. Each slider 1302 is movable in order to expose a respective wireless data system or cover the respective wireless data system with the Faraday shield, thereby activating/de-activating the respective wireless data system. Because each wireless data system is configured to perform one or more functions that may be different from one or more functions performed by the other wireless data systems, respective configurations of the sliders 1302 correspond to selections of a subset of functions performable using the mobile device 1300. Other, unselected functions are physically prevented from being performed, because the wireless data systems that would perform the unselected functions are electromagnetically shielded by the Faraday shields.

In some implementations, the sliders 1302, instead of or in addition to configuring Faraday shields, may be coupled to movable conductors that make and break electrical connections based on positions of the sliders 1302, thereby activating/de-activating the wireless data systems based on respective positions of the sliders 1302.

The user-configurable controls described in this disclosure allow for the selection of a subset of functions even in a partially or wholly passive mobile device, without requiring electronic selection mechanisms (e.g., screens, batteries, and sophisticated processors) that may otherwise be necessary, though some implementations do additionally or instead include these electronic selection mechanisms. Moreover, because the user-configurable controls, in some implementations, physically prevent wireless data system function (e.g., by breaking connections within the wireless data system or by electromagnetically isolating the wireless data system), disabled systems are disabled more securely than they otherwise would be.

In practice, other configurations for mobile devices and secure systems are possible, depending on the implementation. Although individual systems of mobile devices have been described in reference to separate figures, a mobile device may include any combination of the disclosed systems in various implementations.

Various aspects and functional operations of the systems described in this specification, such as operations performed by mobile devices, wireless data systems, anti-breach systems, and base stations may be implemented, at least in part, in digital electronic circuitry, a data processing apparatus, or in computer software, firmware, or hardware, including the structures disclosed in this specification and their structural equivalents, or in combinations of one or more of them. Likewise, various aspects and functional operations of the systems may be implemented as one or more computer program products, i.e., one or more modules of non-transient computer program instructions encoded on a non-transient computer readable medium for execution by, or to control the operation of, a data processing apparatus. The computer readable medium may be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both.

A number of implementations have been described. Nevertheless, it will be understood that various modifications may be made without departing from the spirit and scope of this disclosure. For example, features described above in connection with different embodiments may be combined in the same implementation. Further, some features described above may be omitted in some implementations. Accordingly, other implementations are within the scope of the claims.

What is claimed is:

1. A mobile device comprising:
a body configured to be worn by a user;
a lock switchable between an open state and a closed state, wherein, when the lock is in the closed state, the mobile device is prevented from being removed from the user; and
a wireless data system,
wherein the wireless data system and the lock are jointly configured such that, when the lock is open, the wireless data system is at least partially disabled.

2. The mobile device of claim 1, wherein the wireless data system comprises a data chip and an antenna,
wherein, when the lock is in the open state, the data chip and the antenna are electrically disconnected, and
wherein, when the lock is in the closed state, the data chip and the antenna are electrically connected.

3. The mobile device of claim 1, wherein the lock comprises a movable conductor,
wherein, when the lock is in the open state, the movable conductor is in a first position that causes the wireless data system to be at least partially disabled, and
wherein, when the lock is in the closed state, the movable conductor is in a second position that causes the wireless data system to be enabled.

4. The mobile device of claim 1, wherein the wireless data system comprises an antenna, and
wherein, when the lock is in the open state, a Faraday shield of the mobile device is in a first position such that the Faraday shield blocks the antenna and causes the wireless data system to be at least partially disabled, and
wherein, when the lock is in the closed state, the Faraday shield is in a second position such that the wireless data system is enabled.

5. The mobile device of claim 4, wherein movement of the lock between the open state and the closed state causes movement of the Faraday shield between the first position and the second position.

6. The mobile device of claim 1, comprising a power reception system,
wherein the power reception system and the lock are jointly configured such that, when the lock is in the closed state, the power reception system is disabled.

7. A mobile device comprising:
a wireless data system; and
a physical, user-accessible control that switches the wireless data system between an enabled state and a disabled state, wherein at least some functions of the wireless data system are disabled in the disabled state compared to the enabled state.

8. The mobile device of claim 7, wherein the control comprises a Faraday shield that blocks an antenna of the wireless data system when the control is in a position corresponding to the disabled state of the wireless data system.

9. The mobile device of claim 7, wherein the wireless data system comprises a data chip and an antenna, and
wherein the control comprises a movable conductor that electrically connects the data chip to the antenna when the control is in a position corresponding to the enabled state of the wireless data system.

10. The mobile device of claim 7, comprising a lock switchable between an open state and a closed state, wherein, when the lock is in the closed state, the mobile device is prevented from being removed from a user, and
wherein the control and the lock are jointly configured such that, when the lock is in the open state, the control is in a state corresponding to the disabled state of the wireless data system.

11. The mobile device of claim 7, wherein the mobile device comprises:
a plurality of additional wireless data systems, each additional wireless data system providing a different corresponding functionality; and
one or more additional physical, user-accessible controls that switch the plurality of additional wireless data systems between respective enabled states and disabled states.

12. A mobile device comprising:
one or more wireless data systems; and
an anti-breach system configured to at least partially disable a first wireless data system in response to an unauthorized event.

13. The mobile device of claim 12, wherein the first wireless data system or another wireless data system is configured to receive a wireless proximity signal, and wherein the unauthorized event comprises a failure to receive the wireless proximity signal by the first wireless data system or by another wireless data system.

14. The mobile device of claim 12, wherein the first wireless data system or another wireless data system is configured to receive a wireless alert signal, and wherein the unauthorized event comprises receiving the wireless alert signal by the first wireless data system or another wireless data system.

15. The mobile device of claim 12, wherein the anti-breach system comprises a conductive strip, and wherein the unauthorized event comprises a severing of the conductive strip.

16. The mobile device of claim 12, wherein the anti-breach system comprises a sensor configured to detect one or more of a strain, a force, or a physical violation applied to the mobile device, and
wherein the unauthorized event comprises a strain greater than a predetermined magnitude of strain, a force greater than a predetermined magnitude of force, or a predetermined physical violation.

17. The mobile device of claim 12, comprising a biometric input system, wherein the unauthorized event comprises receiving, by the biometric input system, biometric data that does not match biometric data stored on the mobile device.

18. The mobile device of claim 12, wherein at least partially disabling the first wireless data system comprises causing an electrical charge to damage a portion of the mobile device.

19. The mobile device of claim 12, wherein at least partially disabling the first wireless data system comprises releasing a chemical that damages a portion of the mobile device.

20. The mobile device of claim 12, wherein at least partially disabling the first wireless data system comprises releasing a spring-loaded component that damages a portion of the mobile device.

21. The mobile device of claim 12, wherein at least partially disabling the first wireless data system comprises causing a Faraday shield to block an antenna of the mobile device.

22. The mobile device of claim 12, wherein, in response to the unauthorized event, the anti-breach system is configured to cause a second wireless data system to emit a wireless signal indicative of the unauthorized event.

23. The mobile device of claim 12, comprising an alert component,
wherein, in response to the unauthorized event, the anti-breach system is configured to cause the alert component to generate an alert indicator.

24. A secure system comprising:
a mobile device, the mobile device comprising,
a body configured to be worn by a user, and
a lock switchable between an open state and a closed state, wherein, when the lock is in the closed state, the mobile device is prevented from being removed from the user, and wherein the lock is configured to switch between the open state and the closed state in response to the mobile device receiving a wireless signal; and
a base station configured to transmit the wireless signal.

25. The secure system of claim 24, wherein the mobile device comprises an anti-breach system configured to perform one or more operations in response to an unauthorized event.

26. The secure system of claim 25, wherein the mobile device comprises a wireless data system configured to receive a wireless proximity signal, wherein the unauthorized event comprises a failure to receive the wireless proximity signal, and wherein the base station is configured to emit the wireless proximity signal.

27. The secure system of claim 25, wherein the mobile device comprises a wireless data system configured to receive a wireless alert signal, wherein the unauthorized event comprises receiving the wireless alert signal, and wherein the base station is configured to emit the wireless alert signal.

28. The secure system of claim 24, wherein the base station comprises a charging component configured to charge the mobile device, wherein the mobile device comprises a wireless data system, and
wherein the wireless data system is at least partially disabled while the mobile device is being charged by the base station.

29. The secure system of claim 28, wherein the mobile device comprises a power reception system configured to couple to the charging component, and
wherein the power reception system and the lock are jointly configured such that, when the lock is in the closed state, the power reception system is disabled.

30. The secure system of claim 24, wherein the base station comprises a second mobile device.
